(19) United States
(12) Patent Application Publication
(10) Pub. No.: US 2005/0193259 A1
(43) Pub. Date: Sep. 1, 2005

(54) System and method for reboot reporting

(76) Inventors: Juan I. Martinez, Tomball, TX (US); Scotty Mark Wiginton, Tomball, TX (US); William Paul Swaney, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/781,477

(22) Filed: Feb. 17, 2004

(51) Int. Cl. G06F 11/00

(52) U.S. Cl. 714/34

(57) ABSTRACT

A system and method for reboot reporting or notification is provided. One system embodiment may include, for example, a plurality of computer systems having at least one processor and at least one non-maskable interrupt output, a manager system in circuit communication with the plurality of computer systems and having at least one non-maskable interrupt input associated with the plurality of computer systems.

### BACKGROUND

Computer systems are prone to fault conditions that cause the systems to reboot or restart. These faults also sometimes cause a computer system to “crash” or “hang.” Independent of the exact nature of the fault, crash, or hang, these situations require the computer system to reboot or restart so as to clear the error condition that caused the fault condition. Rebooting or restarting causes a loss of processing ability and, hence, data can be lost and the processing of tasks or instructions may take much longer to execute than would be otherwise be required.

In computer systems that include many individual sub-systems, such as server systems designed to work with many users over a network, the rebooting or restarting of any one or more of these sub-systems may cause a large number of users to experience a loss of computing ability.

### SUMMARY

In one embodiment, a method of reboot reporting is provided. The method includes, for example, reading a plurality of input lines associated with a plurality of computer systems having a plurality of processors, generating at least one non-maskable interrupt signal, outputting the non-maskable interrupt signal to a processor of the plurality of computer systems, outputting the non-maskable interrupt signal to a manager associated with the plurality of computer systems; and generating an indication that at least one computer system has a fault condition.

In another embodiment, a system for rebooting is provided. The system includes, for example, a plurality of computer systems having at least one processor and at least one non-maskable interrupt output, and a manager system in circuit communication with the plurality of computer systems and having at least one non-maskable interrupt input associated with the plurality of computer systems.

### BRIEF DESCRIPTION OF THE DRAWINGS

FIG. 1 is an exemplary diagram of one embodiment of a computer system.

FIG. 2 is a block diagram of one embodiment of a system.

FIG. 3 is a flow chart illustrating one embodiment of processing logic.

FIG. 4 is a flow chart illustrating one embodiment of a method of reboot reporting.

### DETAILED DESCRIPTION OF ILLUSTRATED EMBODIMENTS

The following includes definitions of exemplary terms used throughout the disclosure. Both singular and plural forms of all terms fall within each meaning:

“Signal”, as used herein includes, but is not limited to, one or more electrical signals, analog or digital signals, one or more computer instructions, a bit or bit stream, or the like.

“Logic”, synonymous with “circuit” as used herein includes, but is not limited to, hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Computer” as used herein includes, but is not limited to, any programmed or programmable electronic device that can store, retrieve, and process data.

“Manager” or “manager system” as used herein includes, but is not limited to, any programmed or programmable electronic device that can store, retrieve, and process data for exercising executive, administrative, and supervisory direction or control of other electronic devices.

“Interrupt” as used herein includes, but is not limited to, any signal that can cause a processor to suspend execution of the current program and transfer control to another program called an “interrupt service routine” (ISR), also known as an “interrupt handler.” One type of interrupt is known as a “Non-maskable interrupt.”

“Non-maskable interrupt” as used herein includes, but is not limited to, any notification to a processor of a high-priority system fault occurrence. A non-maskable interrupt (hereinafter NMI) can be generated by, for example, hardware (e.g., peripheral devices) or software (e.g., subroutines). In MICROSOFT WINDOWS® operating systems (hereinafter OS), the generation of an NMI can cause the OS to initiate a reboot or restart.

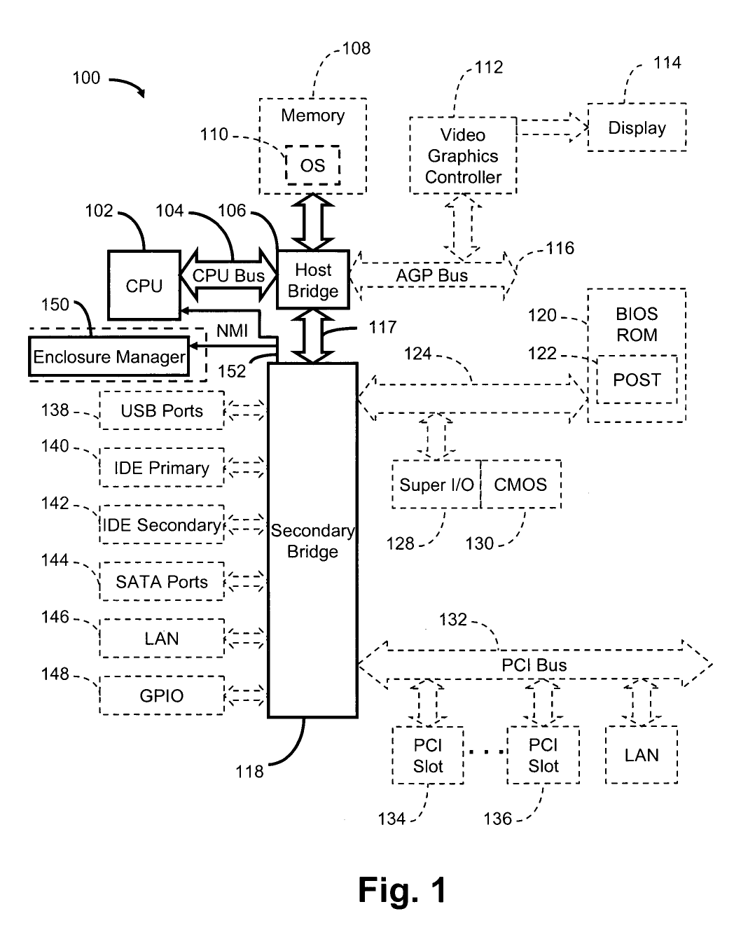

Referring now to FIG. 1, a computer system 100 constructed in accordance with one embodiment generally includes a central processing unit (“CPU”) 102 coupled to a host bridge logic device 106 over a CPU bus 104. CPU 102 may include any processor suitable for a computer such as, for example, a Pentium® class processor provided by Intel. A system memory 108, which may be one or more synchronous dynamic random access memory (“SDRAM”) devices (or other suitable type of memory device), couples to host bridge 106 via a memory bus. System memory 108 can be loaded with an OS such as, for example, a MICROSOFT WINDOWS® OS. Further, a graphics controller 112, which provides video and graphics signals to a display 114, couples to host bridge 106 by way of a suitable graphics bus, such as the Advanced Graphics Port (“AGP”) bus 116. Host bridge 106 also couples to a secondary bridge 118 via bus 117.

For server-based virtual desktop systems such as, for example, Hewlett-Packard's Consolidated Client Infrastructure (CCI) Blade PC Solution, the graphics controller 112 and display 114 are optional. In the CCI Solution, end-users connect one-to-one with dynamically allocated blade personal computers (PC's) housed in a datacenter, via thin clients, to their own personal computing environment. A blade personal computer or server is generally any thin, modular electronic circuit board, having one, two, or more microprocessors and memory, that is typically intended for a single, dedicated application (such as serving Web pages) and that can be easily inserted into a space-saving rack or enclosure with many similar servers. Thin clients are computers that do not have a full complement of application software, data, and CPU power. Such features generally reside on a network server (such as a blade server) to which a thin client communicates, rather than on the thin client computer. As such, thin clients may include a graphics controller and display, along with other peripheral components that a user needs in order to communicate with the network of servers. As will be described in more detail, blade computer systems are typically housed within a rack or enclosure and are typically administered by an enclosure manager.

Secondary Bridge 118 is an I/O controller chipset. The secondary bridge 118 interfaces a variety of I/O or peripheral devices to CPU 102 and memory 108 via the host bridge 106. The host bridge 106 permits the CPU 102 to read data from or write data to system memory 108. Further, through host bridge 106, the CPU 102 can communicate with I/O devices on connected to the secondary bridge 118 and, and similarly, I/O devices can read data from and write data to system memory 108 via the secondary bridge 118 and host bridge 106. The host bridge 106 may have memory controller and arbiter logic (not specifically shown) to provide controlled and efficient access to system memory 108 by the various devices in computer system 100 such as CPU 102 and the various I/O devices. A suitable host bridge is, for example, a Memory Controller Hub such as the Intel® 875P Chipset described in the Intel® 82875P (MCH) Datasheet, which is hereby fully incorporated by reference.

Referring still to FIG. 1, secondary bridge logic device 118 may be, for example, an Ali M1563 Southbridge manufactured by Ali Microelectronics Corporation of San Jose, Calif. or an Intel® 82801EB I/O Controller Hub 5 (ICH5)/Intel® 82801ER I/O Controller Hub 5 R (ICH5R) device provided by Intel and described in the Intel® 82801EB ICH5/82801ER ICH5R Datasheet, both of which are incorporated herein by reference in their entirety. The secondary bridge 118 includes various controller logic for interfacing devices connected to Universal Serial Bus (USB) ports 138, Integrated Drive Electronics (IDE) primary and secondary channels (also known as parallel ATA channels or sub-system) 140 and 142, Serial ATA ports or sub-systems 144, Local Area Network (LAN) connections, and general purpose I/O (GPIO) ports 148. Secondary bridge 118 also includes a bus 124 for interfacing with BIOS ROM 120, super I/O 128, and CMOS memory 130. Secondary bridge 118 further has a Peripheral Component Interconnect (PCI) bus 132 for interfacing with various devices connected to PCI slots or ports 134-136. On the PCI bus, a system error (SERR#) signal generated by one or more PCI components may generate a NMI signal from secondary bridge 118. The primary IDE channel 140 can be used, for example, to coupled to a master hard drive device and a slave floppy disk device (e.g., mass storage devices) to the computer system 100. Alternatively or in combination, SATA ports 144 can be used to couple such mass storage devices or additional mass storage devices to the computer system 100.

The BIOS ROM 120 includes firmware that is executed by the CPU 102 and which provides low level functions, such as access to the mass storage devices connected to secondary bridge 118. The BIOS firmware also contains the instructions executed by CPU 102 to conduct System Management Interrupt (SMI) handling and Power-On-Self-Test (“POST”) 122. POST 122 is a subset of instructions contained with the BIOS ROM 102. During the boot up process, CPU 102 copies the BIOS to system memory 108 to permit faster access.

The super I/O device 128 provides various inputs and output functions. For example, the super I/O device 128 may include a serial port and a parallel port (both not shown) for connecting peripheral devices that communicate over a serial line or a parallel pathway. Super I/O device 128 may also include a memory portion 130 in which various parameters can be stored and retrieved. These parameters may be system and user specified configuration information for the computer system such as, for example, an user-defined computer set-up or the identity of bay devices. The memory portion 130 may be of the type used in National Semiconductor's 97338VJG, which is a complementary metal oxide semiconductor (“CMOS”) memory portion. Memory portion 130, however, can be located elsewhere in the system.

System 100 includes a non-maskable interrupt (“NMI”) signal path 152 in circuit communication with secondary bridge 118, CPU 102, and an enclosure manager 150. In this regard, secondary bridge 118 includes NMI generation circuitry for generating and outputting an NMI signal on NMI signal path 152. As described earlier, an NMI signal indicates the occurrence of a high-priority fault condition that the processor cannot ignore and can be generated by hardware or software. For example, an NMI can be generated by one or more hardware devices (e.g., hard drives) connected secondary bridge 118 or by a watchdog timer circuit within secondary bridge 118 that monitors the initiation and completion of various I/O functions occurring through secondary bridge 118.

The output of the NMI signal can be via a general purpose input/output pin (GPIO) or via a dedicated NMI signal path or pin to the enclosure manager 150. An NMI signal can be generated, for example, if a fault occurs with any of the components communicating with secondary bridge 118 or with secondary bridge 118 itself. The NMI signal so generated is communicated to both CPU 102 and enclosure manager 150 through pathway 152. The generation of the NMI informs CPU 102 and enclosure manager 150 of a fault condition with system 100 that can cause system 100 to restart or reboot.

The enclosure manager 150 is a computer system similar to system 100 but dedicated to the management of other computer systems. Enclosure manger 150 is used when a plurality of computer systems, such as system 100, are located within one or more enclosures or racks so as to perform the function of servers. One example of such a configuration is two or more Hewlett-Packard Company blade servers mounted within a rack or enclosure so as to perform the function of servers or virtual PC systems such as, for example, Hewlett-Packard's CCI Blade PC System. Other computer systems suitable for server use or virtual PC systems may also be employed. In such a system, the enclosure manager may be the Hewlett-Packard company Integrated Administrator that can automatically discover, identify and manage all computer systems or servers within the rack or enclosure (see HP ProLiant BL e-Class Integrated Administrator User Guide, Document No. 249070-004, which is hereby fully incorporated by reference.) Other suitable enclosure managers can also be used.

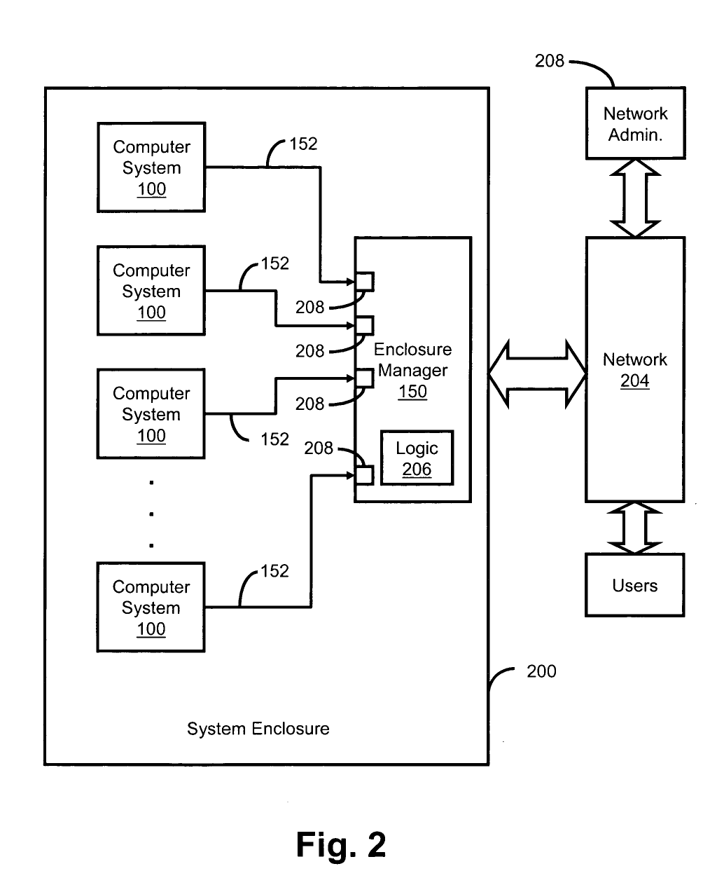

Referring now to FIG. 2, one embodiment of a system is shown. The system includes an enclosure or rack 200 that houses a plurality of computer systems 100 and the enclosure manager 150. The enclosure 200 is in circuit communication with a network 204 that may be, for example, an intranet, internet, extranet, or Local Area Network (LAN). The network 204 allows users to communicate with the enclosure and its computer systems 100 (e.g., servers) to accomplish processing tasks. A network administrator 208 may also be connected to the network 204 for monitoring, managing and administrating network functions and overrides.

Within enclosure 200, each computer system 100 includes an NMI signal pathway 152 to enclosure manager 150. As described earlier, this pathway allows enclosure manager 150 to detect if any computer system 100 has a fault condition that may cause the computer system 100 to reboot or restart. Enclosure manager 150 has logic 206 associated therewith and a plurality of NMI signal inputs 208 to receive the NMI signal outputs generated by computer systems 100. These inputs 208 may be general purpose inputs that are specifically associated with the NMI signal by logic 206. In operation, logic 206 causes enclosure manager 150 to scan or read its NMI signal inputs 208 for detection of the presence of a NMI signal on any particular input. Each input 208 is associated with a particular computer system 100 and upon the detection of an NMI signal, enclosure manager 150 and logic 206 can determine which computer system 100 is in a fault condition and will be rebooting or restarting.

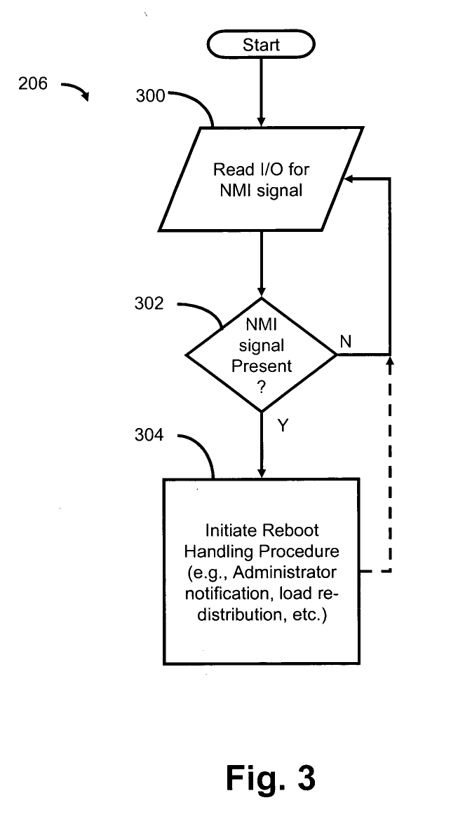

FIG. 3 is one embodiment of a flow diagram illustrating logic 206. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

The logic starts in block 300 where the NMI signal inputs are scanned or read for the presence of a NMI signal from one or more computer systems 100. Block 302 tests each input to determine if a NMI signal is present on any of the NMI signal inputs. If a NMI signal is present on any one or more inputs, the logic advances to block 304. In block 304, the logic initiates a reboot or restart handling procedure. This procedure may include generating a notice or report to network administrator 208 (FIG. 2) that one or more computer systems 100 are in a fault condition and are going to reboot or restart. This will allow the network administrator an opportunity to quickly identify and possibly service the affected computer system 100. This procedure may also include counting the number of times any one or more particular computer systems have generated a NMI interrupt signal and, therefore, a fault condition. This procedure may also further invoke logic for redistributing the processing load entering through network 204 from the computer system 100 that is in the fault condition to one or more other computer systems that are not in a fault condition. Other reboot or restart handling procedures can also be employed or utilized. The logic may then branch or loop back to block 300 to scan or read for the NMI inputs for the next NMI signal.

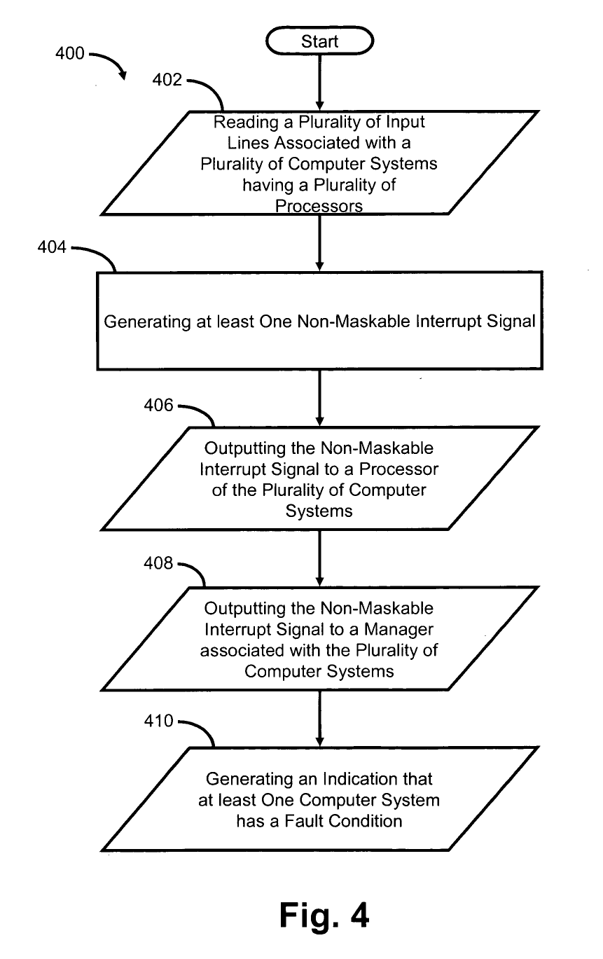

FIG. 4 illustrates a flow chart 400 of one embodiment of a method of reboot reporting. The flow starts in block 402 where it reads a plurality of input lines associated with a plurality of computer systems having a plurality of processors. In block 404, at least one non-maskable interrupt signal is generated. In block 406, the non-maskable interrupt signal is output to a processor of the plurality of computer systems. In block 408, the non-maskable interrupt signal is output to a manager associated with the plurality of computer systems. In block 401, an indication is generated that at least one computer system has a fault condition. The flow may be looped and rerun if desired.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the NMI signal can be any high-priority interrupt signal that the processor is programmed to not ignore and that is communicated to an enclosure manager for fault, reboot or restart notification. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A method of reboot reporting comprising:
reading a plurality of input lines associated with a plurality of computer systems having a plurality of processors;
generating at least one non-maskable interrupt signal;
outputting the non-maskable interrupt signal to a processor of the plurality of computer systems;
outputting the non-maskable interrupt signal to a manager associated with the plurality of computer systems; and
generating an indication that at least one computer system has a fault condition.

2. The method of claim 1 further comprising associating the non-maskable interrupt signal with at least one computer system of the plurality of computer systems.

3. The method of claim 2 further comprising generating a notice identifying the at least one computer system.

4. The method of claim 3 further comprising redistributing the processing load from the at least one computer system to the remaining plurality of computer systems.

5. The method of claim 1 further comprising counting the number of times the non-maskable interrupt signal is generated.

6. A system for reboot reporting comprising:
a plurality of computer systems having at least one processor and at least one non-maskable interrupt output;
a manager system in circuit communication with the plurality of computer systems and comprising at least one non-maskable interrupt input associated with the plurality of computer systems.

7. The system of claim 6 wherein the plurality of computer systems comprises a plurality of non-maskable interrupt outputs and the manager system comprises a plurality of non-maskable interrupt inputs.

8. The system of claim 7 wherein the non-maskable interrupt outputs of the plurality of computer systems are in circuit communication with the plurality of non-maskable inputs of the manager system.

9. The system of claim 6 wherein the plurality of computer systems comprises at least one computer system having a processor, a first bridge circuit and a second bridge circuit and wherein the second bridge circuit comprising a non-maskable interrupt signal output in circuit communication with the processor.

10. The system of claim 9 wherein the non-maskable interrupt output of the second bridge is in circuit communication with the manager system.

11. The system of claim 6 further comprising logic for reading at least one non-maskable interrupt input associated with the plurality of computer systems.

12. The system of claim 11 further comprising logic for generating an indication that at least one computer system has a fault condition based on the presence of a non-maskable interrupt signal present on the at least one non-maskable interrupt input.

13. A system for reboot reporting comprising:
a plurality of computers;
means for managing the plurality of computers; and
means for outputting a non-maskable interrupt signal indicating a fault condition associated with at least one of the plurality of computers to the means for managing.

14. The system of claim 13 further comprising means for detecting the non-maskable interrupt signal indicating a fault condition associated with at least one of the plurality of computers and generating a detection signal in response thereto.

15. The system of claim 13 further comprising means for generating at least one non-maskable interrupt signal.

16. The system of claim 13 further comprising means for generating an indication that at least one computer has a fault condition.

17. The system of claim 13 further comprising means for associating the non-maskable interrupt signal with at least one computer of the plurality of computers.

18. The system of claim 17 further comprising means for redistributing the processing load from the at least one computer to the remaining plurality of computers.

19. The method of claim 13 further comprising means for counting the number of times the non-maskable interrupt signal is generated.

20. A computer system comprising:
a processor;
a memory;
at least one bridge circuit in circuit communication with the processor;
a non-maskable interrupt signal circuit in circuit communication with the processor and at least one other computer system.

21. The system of claim 21 wherein the at least one other computer system comprises an enclosure manager.

22. A system comprising:
an enclosure having a plurality of individual computer systems and a manager computer system;
wherein at least one of the plurality of computer systems comprises a processor and a non-maskable interrupt signal circuit, the non-maskable interrupt signal circuit in communication with the processor and the manager computer system, the non-maskable interrupt signal circuit comprising a bridge circuit and a non-maskable interrupt signal path to the processor and the manager computer system.

23. The system of claim 22 wherein the manager computer system comprises a non-maskable interrupt signal input.

24. The system of claim 23 wherein the manager computer system comprises logic for reading a state of the non-maskable interrupt signal input.

25. The system of claim 24 wherein the manager computer system comprises logic for generating a notice based on the state of the of the read non-maskable interrupt signal input.

26. A system comprising:
means for housing a plurality of digital devices;
means for managing the plurality of digital devices, said means for managing comprising a location within said means for housing;
means for receiving and processing executable instructions, said means for receiving and processing comprising a location within said means for housing;
means for generating a non-maskable interrupt signal; and
means for communicating the non-maskable interrupt signal to the means for receiving and processing and to the means for managing.

27. The system of claim 26 wherein the means for communicating the non-maskable interrupt signal to the means for receiving and processing and to the means for managing comprising a non-maskable interrupt signal pathway.

28. The system of claim 26 wherein the means for managing the plurality of digital devices comprises means for reading the state of the means for communicating and means for generating a notice based on the state of the means for communicating.

29. The system of claim 26 wherein the means for managing the plurality of digital devices comprises means for redistributing a processing distribution among the plurality of digital devices.

30. The system of claim 26 wherein the means for generating a non-maskable interrupt signal comprises a bridge circuit associated with the means for receiving and processing.
